(19) United States
(12) Patent Application Publication
(10) Pub. No.: US 2006/0020644 A1
(43) Pub. Date: Jan. 26, 2006

(54) Method and apparatus for managing documents in computer system

(76) Inventor: Jonathan Eisenstein, Stamford, CT (US)

Correspondence Address: Buckley, Maschoff & Talwalkar LLC, Five Elm Street, New Canaan, CT, 06840, US

(21) Appl. No.: 10/899,441

(22) Filed: Jul. 26, 2004

(51) Int. Cl. G06F 17/30

(52) U.S. Cl. 707/204

(57) ABSTRACT

A plurality of document profiles are stored in a computer system. Each profile is for setting attributes of documents to be stored in the system. At the time a document is to be stored, a document profile is selected and applied to the document. Thereafter the document is managed in the computer system in accordance with the applied profile.

### FIELD

The present invention relates to computer systems, and more particularly to computer systems in which documents are stored.

### BACKGROUND

Modern office computer systems provide convenient facilities for creating and storing documents electronically. However, managing documents once they have been created and stored can present administrative challenges, particularly for large organizations. It is desirable that at least some documents prepared by individuals in the organization be accessible to other members of the organization. Also, document management tools should be available to keep document storage facilities from becoming cluttered, or even overwhelmed, with the passage of time.

### SUMMARY

To alleviate problems inherent in the prior art, the present invention introduces improved apparatus and methods for managing electronic documents.

According to one embodiment, a method includes defining a plurality of document profiles. Each document profile is for setting attributes of documents to be stored in a computer system. The method further includes storing the plurality of document profiles in the computer system, selecting a document, selecting one of the stored document profiles, applying the selected document profile to the selected document, storing the selected document in the computer system, and managing the stored selected document in the computer system in accordance with the document profile applied to the stored selected document.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a computer system according to some embodiments.

FIG. 2 is a block diagram of a server computer that is part of the computer system of FIG. 1.

FIG. 3 is a block diagram of a typical one of the client computers that are part of the computer system of FIG. 1.

FIG. 4 is a flow chart that illustrates a process performed according to some embodiments to define a document profile to be stored in the computer system of FIG. 1.

FIGS. 5 and 6 are views of portions of a screen display window that may be provided in connection with the process of FIG. 4.

FIG. 7 is a flow chart that illustrates a process performed according to some embodiments in connection with storing a document in the computer system of FIG. 1.

FIGS. 8-10 are views of portions of a screen display window that may be provided in connection with the process of FIG. 7.

### DETAILED DESCRIPTION

System Overview

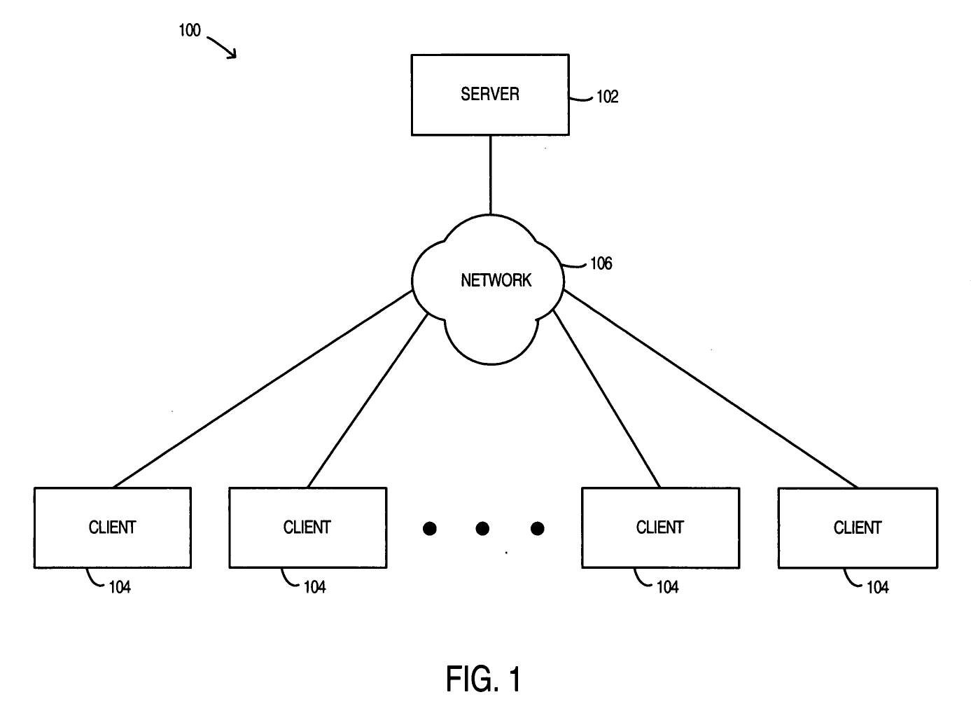

Turning now in detail to the drawings, FIG. 1 is a computer system provided according to some embodiments of the present invention. In FIG. 1, reference numeral 100 generally indicates the computer system. The computer system 100 includes a server computer 102 and a number of client computers 104. The computer system 100 also includes a data communication network 106 which is coupled to the server computer 102 and to the client computers 104 to permit data communication to occur among the server computer 102 and the client computers 104. In some embodiments, the data communication network 106 may be implemented as an intranet, an extranet or a combination of intranet and extranet. In some embodiments, communication over the data communication network 106 may be performed in accordance with the well-known Internet Protocol (IP). The data communication network 106 may be physically realized with any one or more of a public network, a private network, dial-up lines or any combination thereof.

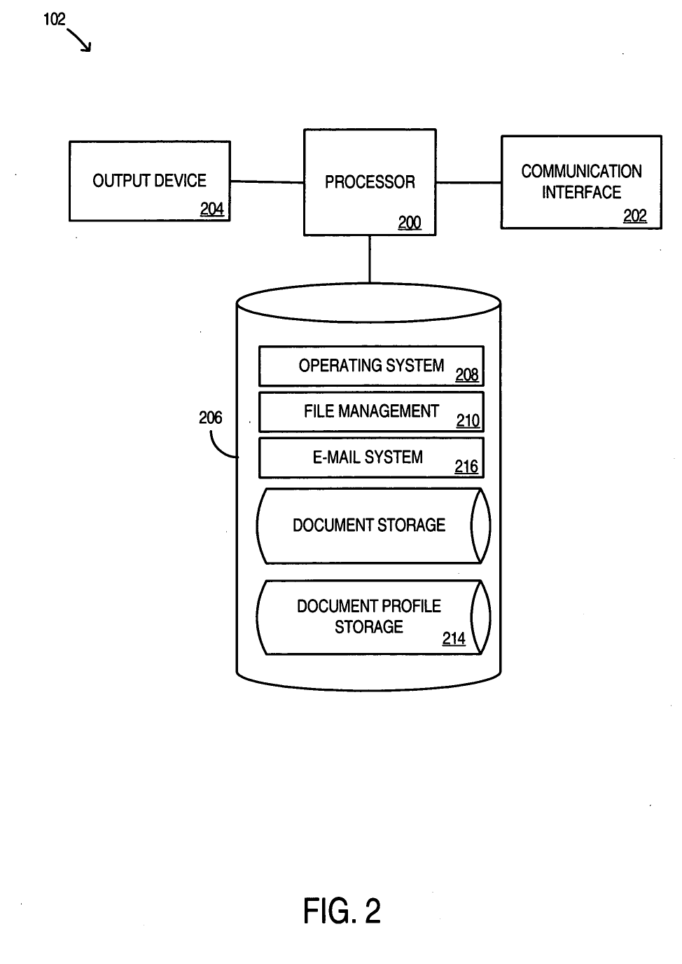

FIG. 2 is a block diagram which shows some details of the server computer 102. In its hardware aspects, the server computer 102 may be entirely conventional, or may be constructed of standard hardware components developed in the future. Moreover, the server computer may include two or more computers that are interconnected and programmed to cooperate with each other. The server computer 102 includes a processor 200, which may be a conventional microprocessor, or a number of processors operating in parallel. The processor 200 is in data communication with a communication interface 202 coupled to the data communication network 106 (FIG. 1). Continuing to refer to FIG. 2, the server computer 102 communicates with other components of the computer system 100, including the client computers 104, through the communication interface 202. The processor 200 is also in data communication with one or more output device(s) 204, which may include one or more displays and/or printers. (Although not shown in the drawing, the server computer 102 may also include one or more input devices, such as keyboards and mice, in data communication with the processor 200.)

Also included in the server computer 102 is a storage device 206, such as a conventional hard disk drive or group of hard drives, in data communication with the processor 200. The storage device 206 stores programs and data which are provided in accordance with some embodiments to control the processor 200 so that the computer system 100 operates in accordance with one or more aspects of the present invention. In particular, the storage device 206 stores an operating system 208 which controls the processor 200 to perform basic functions of the server computer 102. In addition, the storage device 206 stores file management software 210 which controls the processor 200 so that the server computer 102 functions to store and manage files such as documents originally created in the client computers 104 using word processing software, for example. Storage facilities for such documents are schematically indicated at 212 in FIG. 2. In addition, as will be seen, the server computer may store a number of document profiles which are created by one or more system administrative personnel and which are applied to documents stored in the server computer 102 to aid in managing the documents. Storage for the document profiles is indicated at 214.

Continuing to refer to FIG. 2, the storage device 206 further stores electronic mail system software 216 so that the server computer functions as a clearing house to provide for electronic mail communication among the client computers 104. Furthermore, in accordance with some embodiments, the electronic mail system software 212 may also cause the server to operate so that electronic mail communication may occur directly between the server and the client computers 104.

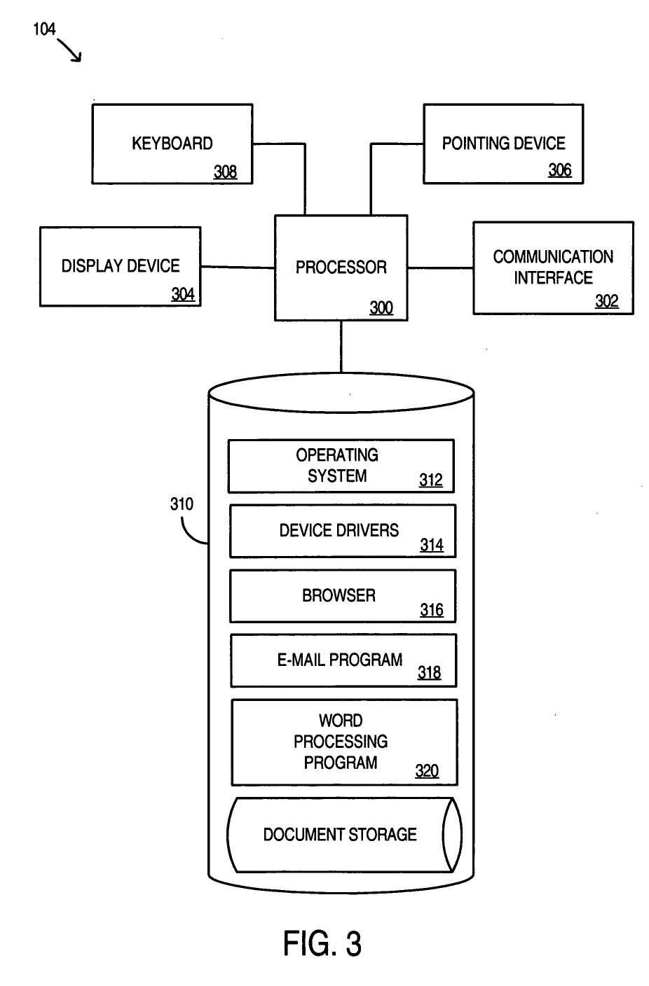

FIG. 3 is a block diagram of a typical one of the client computers 104 shown in FIG. 1. Each client computer 104 may be, in its hardware aspects, constituted in a conventional fashion as a desktop computer, a laptop computer or a notebook computer, for example. As seen from FIG. 3, the typical client computer 104 may include a processor 300 (e.g., a conventional microprocessor) and a communication interface 302 in communication with the processor 300. The communication interface 302 may allow the processor to communicate with other components of the computer system 100 (FIG. 1) such as the server computer 102 and other client computers.

Continuing to refer to FIG. 3, the client computer 104 also includes a display device 304 (e.g., a computer CRT monitor or a flat panel display) in communication with the processor 300, a pointing device 306 (e.g., a computer mouse, a track ball or a touch pad) in communication with the processor 300, and a keyboard 308 in communication with the processor 300. In addition, the client computer 104 includes a storage device 310, which may be a hard drive, for example.

The storage device 310 may store the following software: (a) an operating system 312, (b) device drivers 314 for controlling and/or receiving input from peripheral devices such as the communication interface 302, the display device 304, the pointing device 306 and the keyboard 308, (c) a browser 316 which allows the client computer 104 to operate as a client device relative to the server computer 102 (FIG. 1) and to access web pages and other server functions provided by the server computer, (d) client electronic mail software 318, and (e) a word processing program 320. Indicated at 322 are facilities in the storage device 310 for storing documents created using the word processing program 320.

In some embodiments, all of the software stored in the storage device 310 may be conventional, with all of the custom software and/or data required for the processes described below resident on the server computer 102 and accessible via standard client software on the client computers 104.

In some embodiments, all of the client computers may be dedicated to users who are employees of a corporation that operates the computer system 100.

The server computer 102 may, but need not, be located on premises controlled by the corporation. In some embodiments, the server computer may be maintained on the premises of a contractor who provides web hosting and/or other services to the corporation, with the understanding that access to the document management and other functions performed by the server computer 102 for the corporation are limited to authorized employees or associates of the corporation. In some embodiments, the computer system 100 and/or some or all of its components may also be used for purposes besides those described herein.

Document Management with Pre-defined Document Profiles

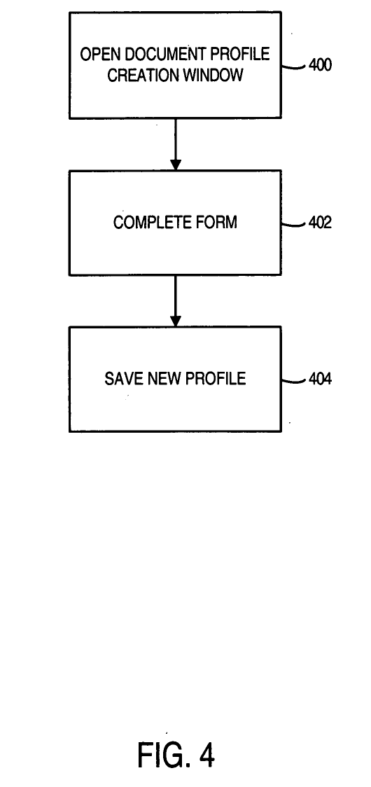

FIG. 4 is a flow chart that illustrates a process performed according to some embodiments to define a document profile to be stored in the computer system 100. As will be seen, the document profile may be used to set attributes of documents to be stored in the computer system 100. The attributes may be referred to by the server 102 in managing documents stored in the document storage facility 212 of the storage device 206.

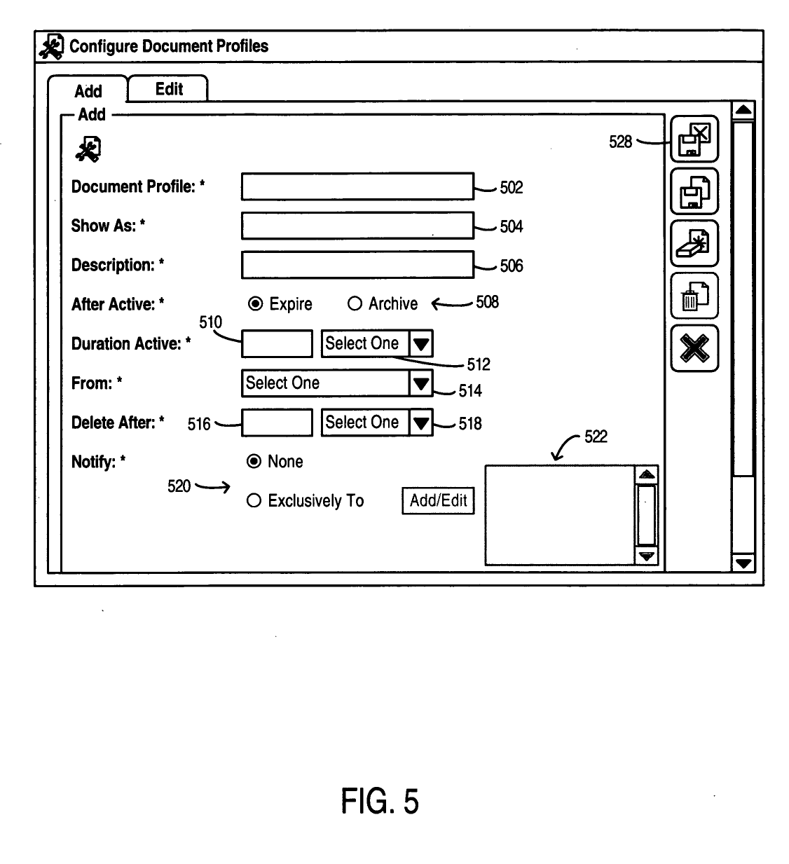

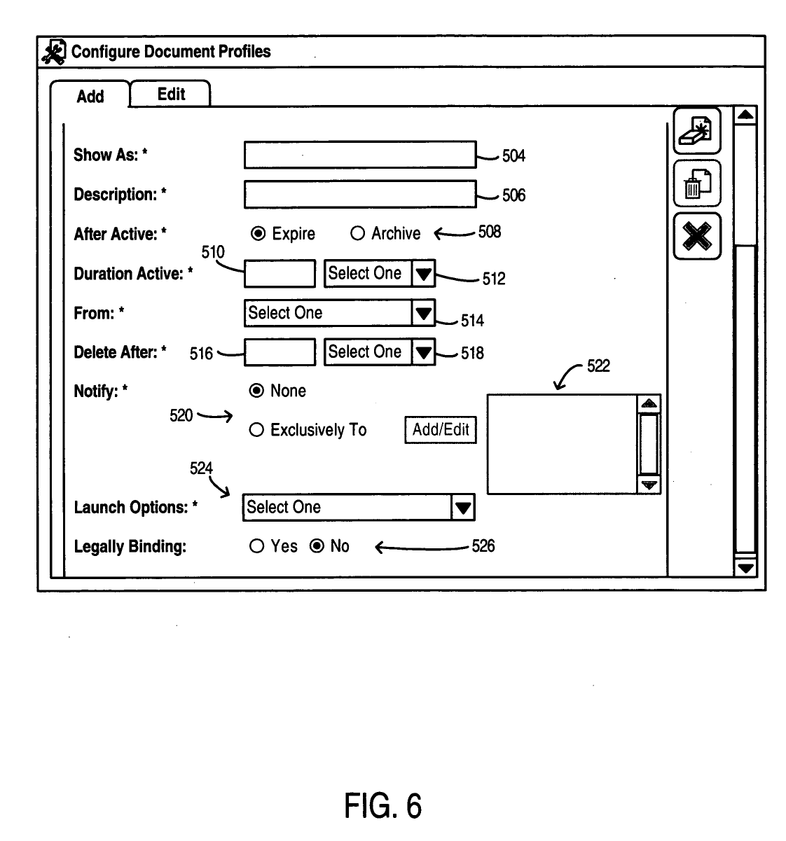

In some embodiments only one or a few administrative personnel for the computer system 100 may be authorized/enabled to have access to a document profile creation tool that is part of the file management software 210 of the server 102. The process of FIG. 4 is launched by such an administrative person accessing the document profile creation tool and defining a document profile. As a first step in the process of FIG. 4 (indicated at 400), a document profile creation window, illustrated in FIGS. 5 and 6, is opened. It will be observed that the view in FIG. 5 corresponds to an upper portion of the window, and the view in FIG. 6 corresponds to a lower portion of the window. The window may be displayed on a display device 304 (FIG. 3) of a client computer 104 operated by the administrative person.

It will be noted that the window shown in FIGS. 5 and 6 presents a form to be filled out by the administrative person. The form may be completed by the administrative person to set attributes of documents to be stored in the computer system 100 in cases where the profile now being defined is applied to the document in question. Completion of the form by the administrative person is indicated at 402 in FIG. 4.

Details of the example document profile definition form shown in FIGS. 5 and 6 will now be described.

Indicated at 502 in FIG. 5 is a text entry field in which the administrative person may enter text to define a name that will be used to refer to the document profile now being defined. Indicated at 504 is another text entry field in which the administrative person may enter text to define another designation for the document profile now being defined. The designation entered in the text entry field 504 may be shorter than the name entered in the text entry field 502 and may be more suitable for being displayed in some circumstances.

Reference numeral 506 indicates another text entry field in which the administrative person may enter text which describes, for example, what types of documents the document profile is to be applied to.

Reference numeral 508 indicates a set of “radio buttons” (in this example, two buttons), of which one is to be selected by the administrative person to indicate a particular inactive status to be applied to the document in question upon expiration of the document's active status. As used herein, an “inactive status” of a document refers to a status of a document stored on the server computer in which the document's searchability and/or accessibility is limited as compared to an active status of the document. That is, in an inactive status, the community of users who may access the document may be limited (in some cases limited to one or more administrative personnel). In addition or alternatively, the document may not be returned in response to a search query unless a special query attribute is asserted, and/or unless a special search privilege is available to the user.

As shown at 508, “archived” and “expired” are examples of designations that may be used for different types of inactive statuses. Such different types of inactive statuses may differ from each other in terms to the searchability and/or accessibility of the documents having the respective inactive statuses.

A numeric entry field 510 and a dropdown menu 512 are provided together to allow the administrative person to set the attribute for the document which specifies how long the document will remain in an active status. The options provided in the dropdown menu 512 (which are not shown) may include, for example, “week(s)”, “month(s)” and “year(s)”. The numeric entry field 510 may accept numerals such as “1”, “2”, “3”, etc. Together, the numeric entry field 510 and the dropdown menu 512 may allow the administrative person to specify a duration of active status for the document such as six months, two years, five years, and so forth.

A dropdown menu 514 is provided to allow the administrative person to set the date from which the end of the active period will be measured. The options presented (but not shown in the drawing) by the dropdown menu 514 may include “Created Date” or “Last Modified Date”. This allows the user to choose that the active duration of the document be measured from either the date of the last edit of the document or from the original date of creation of the document. This may provide additional flexibility in the capabilities of the system.

A numeric entry field 516 and a dropdown menu 518 are provided together to allow the administrative person to set the attribute for the document which specifies how long the document will remain in the inactive status before being deleted from the system. As in the case of the field 510 and menu 512 discussed above, the numeric entry field 516 and the dropdown menu 518 may together be used to specify a period of time such as six months, two years, five years (or six years, which may be an appropriate period to archive a contract after its time in active status has ended). Effectively, the information entered into field 516 and menu 518 may set the point in time at which the document is deleted from the computer system 100.

At 520 is a set of radio buttons that allows the administrative person to select whether or not notification by electronic mail is to be provided to certain users when a document subject to the profile is stored in the system. If the administrative person opts for providing notification, the names of users who are to receive the notifications may be entered in the field shown at 522. Entry of these user names may be made by, e.g., selecting the names from a roster or the like.

Referring now to FIG. 6, a dropdown menu is provided at 524 to allow the administrative person to select among options for “launching” documents subject to the profile when such documents are opened by a user. That is, the option selected via the menu 524 may determine whether opening of the document results in only descriptive information about the document being initially displayed, or alternatively whether the document itself is immediately displayed upon being opened.

At 526 is a set of radio buttons that allows the administrative person to select whether documents subject to the profile are to have a certain administrative characteristic that calls for a standard notice (e.g., text of a type sometimes referred to as a “legal disclaimer”) to be displayed and/or printed with the document.

When the administrative person has completed the form shown in FIGS. 5 and 6, he or she may, as indicated at 404 in FIG. 4, actuate a button (e.g., a “save and close” button 528, FIG. 5) to cause the profile defined by the information entered into the form to be stored in the document storage facility 214 (FIG. 2) of the server 102.

It should be understood that the process of FIG. 4 may be performed a number of times to define a number of different profiles. For example, different profiles may be entered for “sale contracts”, “lease contracts” and “purchase contracts”. As a result, a number of different profiles may be stored in the document storage facility 214 of the server 102.

The set of document attributes selected and/or entered with the form shown in FIGS. 5 and 6 may be satisfactory for many applications. Alternatively, additional attributes may be included in the profile definition form, and/or some of the attributes included in the illustrated form may be omitted in some embodiments.

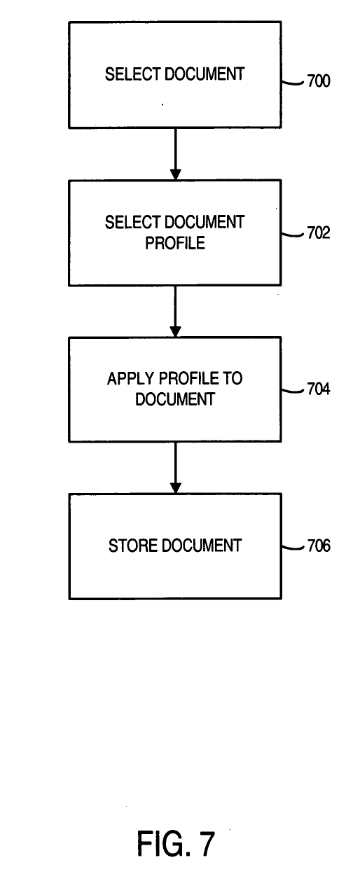

FIG. 7 is a flow chart that illustrates a process performed according to some embodiments in connection with storing a document in the computer system 100.

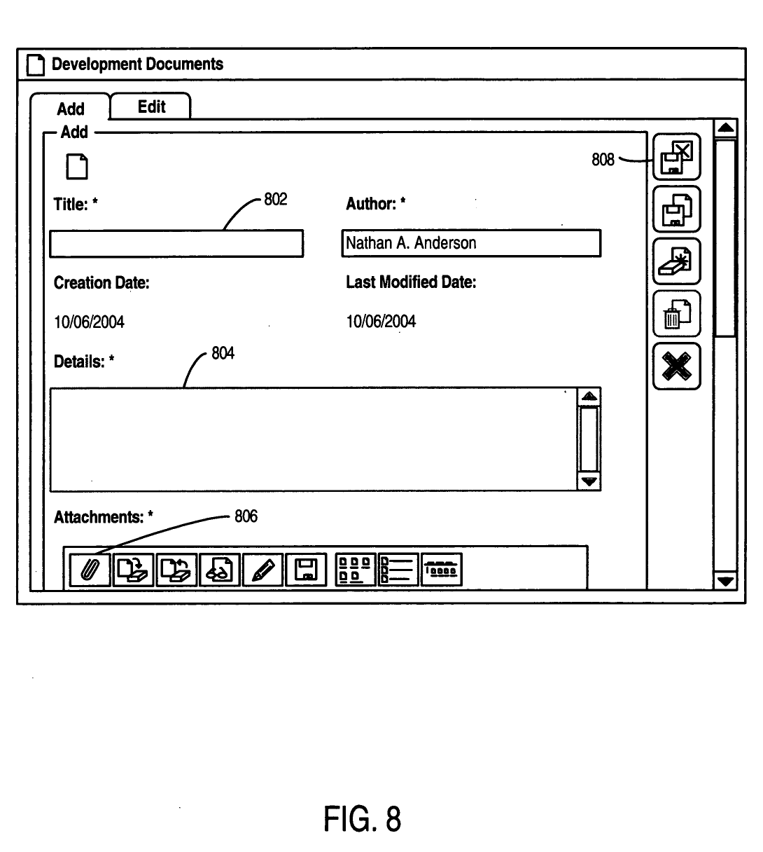

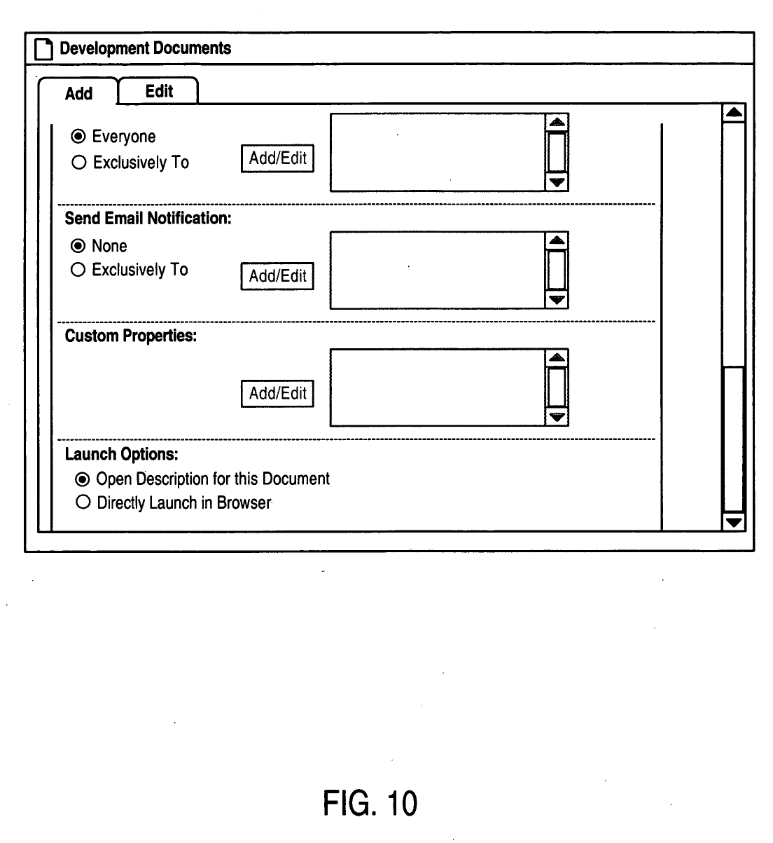

The process of FIG. 7 may be initiated by a user operating one of the client computers 104. In some embodiments, users who perform the process of FIG. 7 may be required to have certain administrative privileges in the computer system 100. In other embodiments, the process of FIG. 7 may be available to all users of the computer system 100. In any case, the process may be launched, for example, upon the user selecting an appropriate option such as “store document” from a menu which is not shown. Upon launching the process, a window like that illustrated in FIGS. 8-10 may be displayed on the display device 304 of the user's client computer 104. FIGS. 8-10 respectively show upper, middle and lower portions of the window.

Referring to FIG. 8, fields 802 and 804 are respectively provided to allow the user to enter title and descriptive information for the document to be stored. Also, as indicated at 700 in FIG. 7, the user may select the document to be stored by actuating a button 806 (FIG. 8) to invoke an “attach” function. In accordance with conventional practices, the attach function may allow the user to browse a file directory to locate a document stored in the document storage facility 322 of the storage device 310 of the user's computer 104. The document in question may, for example, have previously been created by the user by using the word processing program 320. For example, the document in question may be a contract or other document for which a previously defined standard document profile is required and/or is appropriate. Other specific techniques for selecting a document may alternatively or additionally be employed.

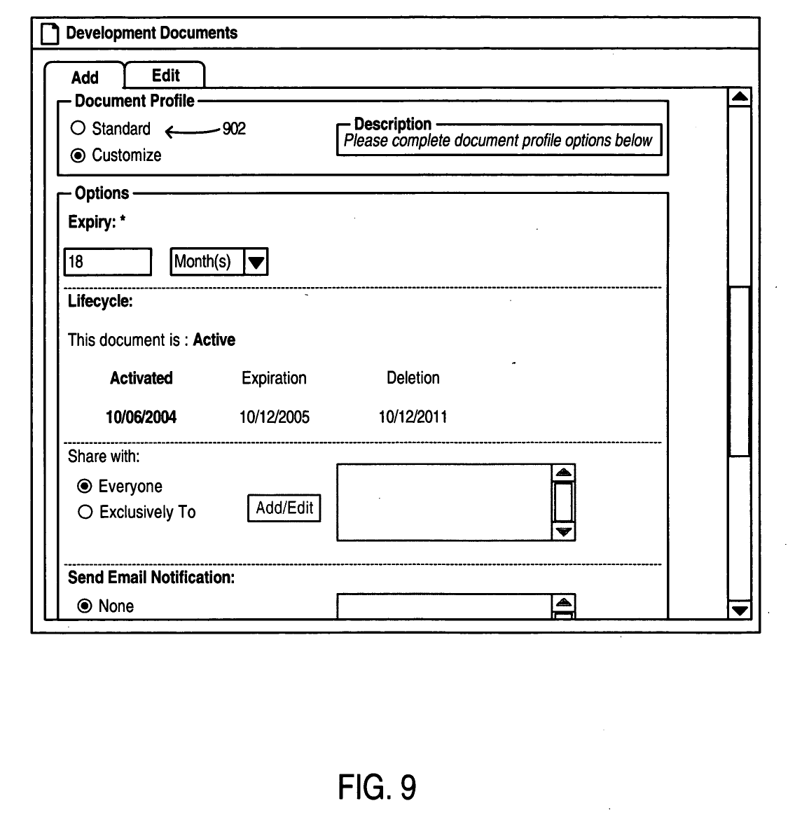

Referring to FIG. 9, a set of radio buttons 902 is provided to allow the user to indicate whether the document to be stored is to be subject to a previously stored standard document profile or subject to a customized document profile to be defined by the user via the window of FIGS. 8-10. If the user actuates the radio button marked “standard”, the user may be provided with options (e.g., via a pop-up menu which is not shown) to allow the user to select among the various standard document profiles that had previously been stored in the document profile storage facility 214 of the server computer 102. For example, options such as “sale contract”, “lease contract”, “purchase contract” may be presented. By selecting one of the options, the user selects one of the standard document profiles, as indicated at 702 in FIG. 7. Next, as indicated at 704 and 706 in FIG. 7, the user may cause the selected standard document profile to be applied to the selected document and may cause the selected document to be stored in the document storage facility 212 of the storage device 206 of the server computer 102. This may be done, for example, in response to the user actuating a “save and close” button 808 (FIG. 8) provided in the window. In the event that a custom document profile is to be applied to the document to be stored, the user may enter the required information for the custom document profile via the window.

Once the document has been stored in the server 102, the server may manage the document in accordance with the standard or custom document profile applied to the document. For example, the starting date, duration and ending date of the period of active status for the document may be determined in accordance with attributes set by the standard document profile applied to the document. Further, the type and duration of inactive status applied to the document upon expiration of its active status may also be determined in accordance with attributes set by the standard document profile applied to the document. Thus, the document may be deleted from the storage device 206 of the server 102 at a time (e. g., date) indicated by one or more attributes set by the standard document profile applied to the document.

Moreover, the individual users and/or groups of users granted access to the document stored in the server may be determined in accordance with an attribute set by the standard document profile applied to the document. In addition, in accordance with an attribute set by the standard document profile applied to the document, the server 102 may send an electronic mail message to one or more users to notify the user(s) that the document has been stored in the server.

Still further, the manner in which the document is displayed to a user (e.g., immediately opened or opened only on user input after a description of the document is presented; and/or displayed only in association with a standard notice such as a legal disclaimer) may be determined in accordance with one or more attributes set by the standard document profile applied to the document.

It will be appreciated that one of the standard document profiles may be applied to some documents as they are stored, and other document profiles may be applied to other documents as they are stored.

The use of pre-defined standard document profiles to determine management of documents stored in a computer system may aid users in making their documents available to the community of users of the computer system. At the same time, the standard document profiles may aid the administrators of the system in guarding against clutter and excessive use of storage facilities, while also enforcing legal or other requirements for document retention.

The present invention has the technical effect of facilitating electronic storage and management of documents in a computer system.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
defining a plurality of document profiles, each document profile for setting attributes of documents to be stored in a computer system;
storing the plurality of document profiles in the computer system;
selecting a document;
selecting one of the stored document profiles;
applying the selected document profile to the selected document;
storing the selected document in the computer system; and
managing the stored selected document in the computer system in accordance with the document profile applied to the stored selected document.

2. The method of claim 1, wherein the attributes include at least one of:
(a) a period of time during which the document is to be maintained in an active status;
(b) a type of status to be applied to the document after the active status;
(c) a period of time during which the document is to be maintained in an inactive status;
(d) a point in time at which the document is to be deleted from the computer system;
(e) a determination as to whether an electronic mail notification is to be provided to at least some users of the computer system upon storing of the document;
(f) a manner in which the document is to be presented to a user via a display component of the computer system; and
(g) a determination as to whether a standard notice is to be displayed with the document on the display component of the computer system.

3. The method of claim 1, wherein the selected document is a contract.

4. The method of claim 1, wherein the defining includes selecting options from menus presented on a display component of the computer system.

5. The method of claim 4, wherein the menus are dropdown menus.

6. The method of claim 1, wherein the selecting of the one of the stored document profiles includes selecting an option from a menu.

7. The method of claim 6, wherein the menu is a pop-up menu.

8. The method of claim 1, wherein the managing includes deleting the stored document at a time indicated by an attribute set by the document profile applied to the stored document.

9. The method of claim 1, wherein the managing includes controlling access to the stored document in accordance with an attribute set by the document profile applied to the stored document.

10. The method of claim 1, further comprising:
sending an electronic mail message to at least one user of the computer system to notify the at least one user of the storing of the selected document, the notifying in accordance with an attribute set by the document profile applied to the stored selected document.

11. The method of claim 1, further comprising:
displaying the stored document on a display component of the computer system, the displaying in accordance with an attribute set by the document profile applied to the stored document.

12. An apparatus comprising:
means for defining a plurality of document profiles, each document profile for setting attributes of documents to be stored in a computer system;
means for storing the plurality of document profiles in the computer system;
means for selecting a document;
means for selecting one of the stored document profiles;
means for applying the selected document profile to the selected document;
means for storing the selected document in the computer system; and
means for managing the stored selected document in the computer system in accordance with the document profile applied to the stored selected document.

13. The apparatus of claim 12, wherein the attributes include at least one of:
(a) a period of time during which the document is to be maintained in an active status;
(b) a type of status to be applied to the document after the active status;
(c) a period of time during which the document is to be maintained in an inactive status;
(d) a point in time at which the document is to be deleted from the computer system;
(e) a determination as to whether an electronic mail notification is to be provided to at least some users of the computer system upon storing of the document;
(f) a manner in which the document is to be presented to a user via a display component of the computer system; and
(g) a determination as to whether a standard notice is to be displayed with the document on the display component of the computer system.

14. The apparatus of claim 12, wherein the selected document is a contract.

15. The apparatus of claim 12, wherein the means for defining includes means for selecting options from menus presented on a display component of the computer system.

16. The apparatus of claim 15, wherein the menus are dropdown menus.

17. The apparatus of claim 12, wherein the means for selecting one of the stored document profiles includes means for selecting an option from a menu.

18. The apparatus of claim 17, wherein the menu is a pop-up menu.

19. The apparatus of claim 12, wherein the means for managing includes means for deleting the stored document at a time indicated by an attribute set by the document profile applied to the stored document.

20. The apparatus of claim 12, wherein the means for managing includes means for controlling access to the stored document in accordance with an attribute set by the document profile applied to the stored document.

21. The apparatus of claim 12, further comprising:
means for sending an electronic mail message to at least one user of the computer system to notify the at least one user of the storing of the selected document, the notifying in accordance with an attribute set by the document profile applied to the stored selected document.

22. The apparatus of claim 12, further comprising:
a display component; and
means for displaying the stored document on the display component, the displaying in accordance with an attribute set by the document profile applied to the stored document.

23. A method comprising:
defining a plurality of document profiles, each document profile for setting attributes of documents to be stored in a server computer;
storing the plurality of document profiles in the server computer;
selecting a document stored in a client computer;
selecting one of the document profiles stored in the server computer;
applying the selected document profile to the selected document;
storing the selected document in the server computer; and
managing the selected document in the server computer in accordance with the document profile applied to the selected document.
